(19) United States
(12) Patent Application Publication
(10) Pub. No.: US 2026/0299492 A1
(43) Pub. Date: Oct. 1, 2026

(54) IMAGE FORMING APPARATUS AND CONTROL METHOD OF IMAGE FORMING APPARATUS

(71) Applicant: KYOCERA Document Solutions Inc., Osaka (JP)

(72) Inventors: Masayuki Mochizuki, Osaka (JP); Takuya Aritsuki, Osaka (JP); Hayato Kusuda, Osaka (JP)

(21) Appl. No.: 19/564,619

(22) Filed: Mar. 12, 2026

(30) Foreign Application Priority Data
Mar. 31, 2025 (JP) 2025-058554

(51) Int. Cl. G03G 15/00

(52) U.S. Cl. CPC G03G 15/6558; G03G 15/5029; G03G 2215/00569; G03G 2215/00599; G03G 2215/00679; G03G 2215/00734; G03G 2215/00738; G03G 2215/00746

(57) ABSTRACT

An image forming apparatus includes an image forming portion and a selection processing portion. The image forming portion conveys a sheet so that the sheet reaches a forming position at a forming timing at which formation of an image is started, and forms the image on the sheet. The selection processing portion selects one of a first mode and a second mode as a mode to be used in the image forming portion in accordance with a specific condition. The first mode is a mode in which a conveying speed is changed without stopping the sheet at a position of a correction portion for correcting an inclination of the sheet. The second mode is a mode in which the sheet is temporarily stopped at the position of the correction portion.

### INCORPORATION BY REFERENCE

This application is based upon and claims the benefit of priority from the corresponding Japanese Patent Application No. 2025-058554 filed on Mar. 31, 2025, the entire contents of which are incorporated herein by reference.

The present disclosure relates to an image forming apparatus and a control method of the image forming apparatus.

### BACKGROUND

As a related art, an image forming apparatus is known that reduces variations in longitudinal registration by making a correction to ensure a constant time from when a registration roller is driven until a leading edge of a sheet reaches a transfer position. In this image forming apparatus, a sheet sensor is provided downstream of the registration roller and upstream of the transfer position, and the sheet feed speed by the registration roller is increased or decreased in accordance with the time from when the registration roller is driven until the leading edge of the sheet reaches the position of the sheet sensor.

The image forming apparatus according to the related art stops the registration roller to hold the sheet at the position of the registration roller until the process of preparing an image to be transferred to the sheet is completed. After the above process is completed, the image forming apparatus performs control to drive the registration roller to convey the sheet to the transfer position.

### SUMMARY

An image forming apparatus according to an aspect of the present disclosure includes an image forming portion and a selection processing portion. The image forming portion conveys a sheet so that the sheet reaches a forming position at a forming timing at which formation of an image is started, and forms the image on the sheet. The selection processing portion selects one of a first mode and a second mode as a mode to be used in the image forming portion in accordance with a specific condition. The first mode is a mode in which a conveying speed is changed without stopping the sheet at a position of a correction portion for correcting an inclination of the sheet. The second mode is a mode in which the sheet is temporarily stopped at the position of the correction portion.

A control method of an image forming apparatus according to another aspect of the present disclosure includes conveying a sheet so that the sheet reaches a forming position at a forming timing at which formation of an image is started, and forming the image on the sheet. The control method of the image forming apparatus includes selecting one of a first mode and a second mode as a mode to be used in a process of forming the image in accordance with a specific condition. The first mode is a mode in which a conveying speed is changed without stopping the sheet at a position of a correction portion for correcting an inclination of the sheet. The second mode is a mode in which the sheet is temporarily stopped at the position of the correction portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic cross-sectional view showing a configuration of an image forming apparatus according to an embodiment.

FIG. 2 is a schematic diagram showing a configuration of a main part of the image forming apparatus according to the embodiment.

FIG. 3 is a schematic block diagram showing a configuration of the image forming apparatus according to the embodiment.

FIG. 4 is a schematic diagram showing sheet deceleration processing in the image forming apparatus according to the embodiment.

FIG. 5 is a flowchart showing a first operation example of the image forming apparatus according to the embodiment.

FIG. 6 is a flowchart showing a second operation example of the image forming apparatus according to the embodiment.

FIG. 7 is a flowchart showing a third operation example of the image forming apparatus according to the embodiment.

FIG. 8 is a flowchart showing a fourth operation example of the image forming apparatus according to the embodiment.

FIG. 9 is a flowchart showing a fifth operation example of the image forming apparatus according to the embodiment.

### DETAILED DESCRIPTION

### Embodiment

An embodiment of the present disclosure will be described below with reference to the accompanying drawings. The following embodiment is an example of embodying the present disclosure and is not intended to limit the technical scope of the present disclosure.

### [1] Image Forming Apparatus

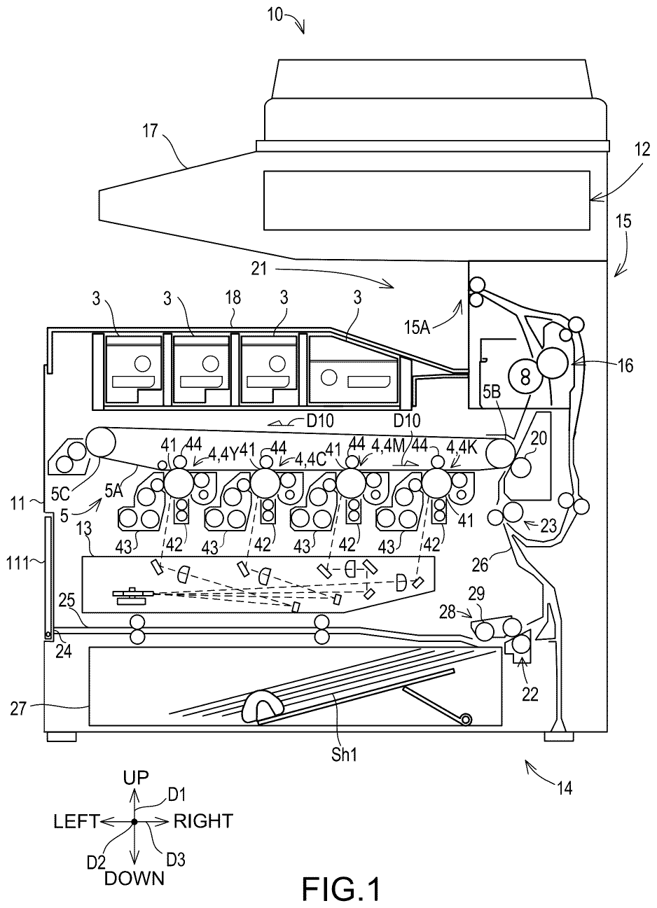

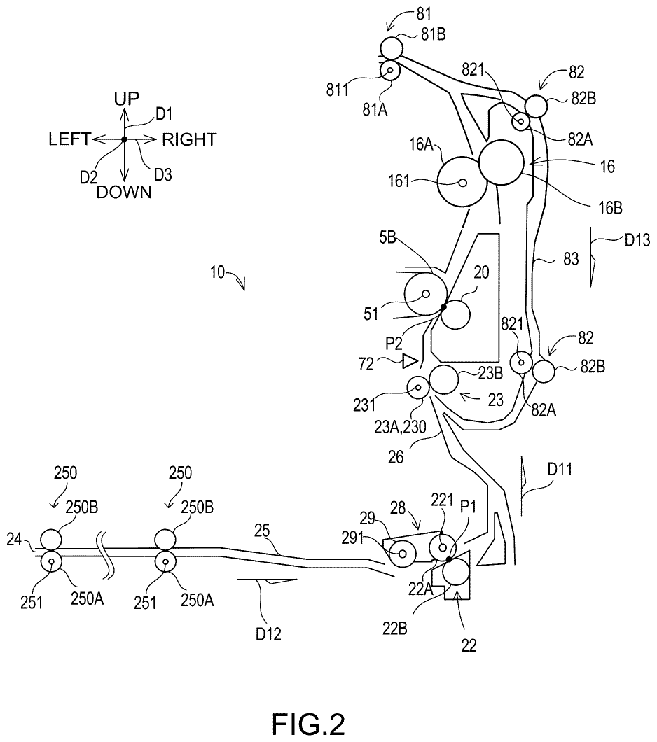

First, an overall configuration of an image forming apparatus 10 according to the present embodiment will be described with reference to FIG. 1 and FIG. 2. In the following description, the up-down direction D1, the front-rear direction D2, and the left-right direction D3 are defined based on the state in which the image forming apparatus 10 is installed in a usable state (the state shown in FIG. 1).

As shown in FIG. 1, the image forming apparatus 10 is a multifunction peripheral capable of printing an image on a sheet Sh1 such as printing paper, and has various functions such as a print function, a copy function, a facsimile function, and a scan function. In the present embodiment, the image forming apparatus 10 further includes a double-sided printing function for printing images on both sides of the sheet Sh1. It is noted that the image forming apparatus 10 is not limited to a multifunction peripheral, but may be any apparatus having a print function for printing an image on a conveyed sheet Sh1, such as a printer, a copier, or a facsimile machine.

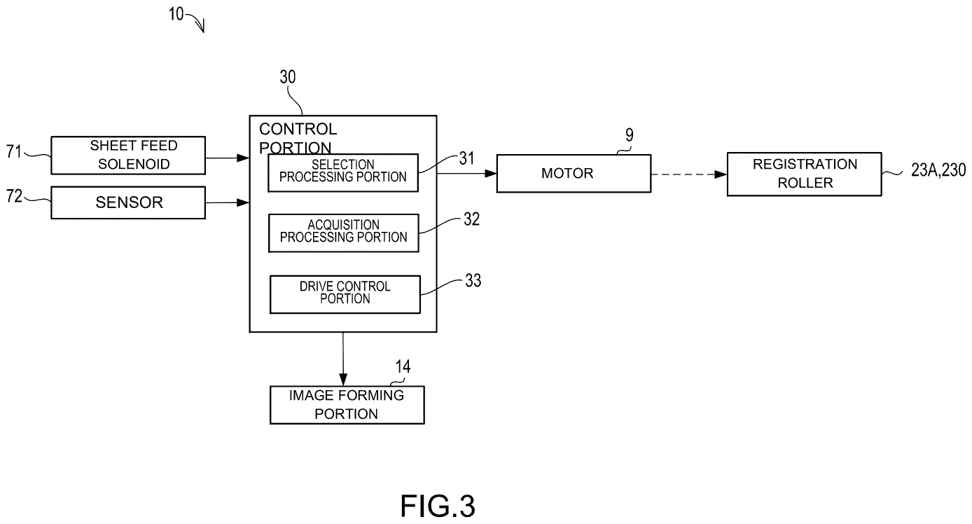

The image forming apparatus 10 includes an image reading portion 12, an image forming portion 14, an operation display portion 17, and a control portion 30 (see FIG. 3). The image reading portion 12 is a portion that performs a process of reading an image of a document sheet, and is provided in an upper portion of the image forming apparatus 10. The image forming portion 14 is a portion that performs a process of forming a monochrome image or a color image based on an electrophotographic method, and is provided in a lower part of the image forming apparatus 10. In addition, a sheet discharge portion 15 is provided on the right side of the image forming portion 14.

A discharge space 21 is provided above the image forming portion 14. The sheet discharge portion 15 connects the image forming portion 14 and the image reading portion 12 vertically, while forming the discharge space 21 between the image forming portion 14 and the image reading portion 12.

The sheet discharge portion 15 discharges the sheet Sh1 after image formation to the discharge space 21. A sheet discharge slot 15A is formed in the left side surface of the sheet discharge portion 15 on the discharge space 21 side. The sheet Sh1 is discharged from the sheet discharge slot 15A.

The image forming portion 14 includes a housing 11 as an apparatus main body. Inside the housing 11, various elements that constitute the image forming portion 14 are provided. The housing 11 includes an exterior frame that covers the entire image forming portion 14 and an internal frame that supports each portion that constitutes the image forming portion 14.

A cover 111 is provided on the front surface of the housing 11 to open the interior of the housing 11. The cover 111 is rotatably supported by a support shaft (not shown) that is provided at the lower end of the opening in the front surface of the housing 11 and extends in the front-rear direction D2.

When the cover 111 is open, a sheet feed slot 24 provided in the front surface of the housing 11 is exposed to the outside of the housing 11. The sheet feed slot 24 is used when the user manually inserts sheets Sh1 one by one into the interior of the housing 11. Hereinafter, the sheet Sh1 inserted from the sheet feed slot 24 is also referred to as a “manually fed sheet.”

The image forming portion 14 forms a monochrome image or a color image on a sheet Sh1, such as printing paper, based on a so-called tandem system. As shown in FIG. 1, the image forming portion 14 includes a plurality of image forming units 4, an intermediate transfer unit 5, a laser scanning unit 13, a secondary transfer roller 20, a fixing device 16, a sheet tray 18, a sheet storing portion 27, and a feed unit 28. In addition, the image forming portion 14 includes a manual feed conveying path 25, a sheet conveying path 26 (hereinafter referred to as a “conveying path 26”), a sheet correction unit 23, and a toner container 3. Furthermore, the image forming portion 14 includes a discharge roller pair 81, two double-sided printing feed roller pairs 82, a double-sided printing conveying path 83, and the like.

The conveying path 26 is a guide path that guides the sheet Sh1 fed by the feed roller pair 22 to the sheet discharge slot 15A. The conveying path 26 curves upward from the feed roller pair 22 and then extends upward, passing through the secondary transfer roller 20 and reaching the sheet discharge slot 15A.

The sheet storing portion 27 is provided at the bottom of the image forming apparatus 10. The sheet storing portion 27 is a portion that stores sheets Sh1 onto which images are transferred by the image forming units 4, and is formed, for example, in the shape of a tray with an open top. The sheet storing portion 27 is supported by the housing 11.

The feed unit 28 takes out a plurality of sheets Sh1 stacked in the sheet storing portion 27 one by one, and feeds the sheets Sh1 toward the conveying path 26. The feed unit 28 includes a sheet feed solenoid 71 (see FIG. 3), a pickup roller 29, and a feed roller pair 22. The sheet feed solenoid 71, the pickup roller 29, and the feed roller pair 22 are provided above a right side portion of the sheet storing portion 27.

Specifically, as shown in FIG. 2, the feed roller pair 22 receives a driving force from a motor 9 (see FIG. 3) to convey the sheet Sh1 downstream in the conveying direction D11. The feed roller pair 22 includes a first driving roller 22A that rotates when a driving force from the motor 9 is transmitted, and a first driven roller 22B that is brought into contact with the first driving roller 22A and is driven to rotate.

The first driving roller 22A is fixed to a rotation shaft 221 extending in the front-rear direction D2, and this rotation shaft 221 is rotatably supported by the internal frame of the housing 11. The driving force from the motor 9 is transmitted to the rotation shaft 221. The driving force of the motor 9 is transmitted to the rotation shaft 221 via a transmission mechanism (not shown) such as a gear or a belt.

The first driven roller 22B is biased toward the first driving roller 22A by a spring (not shown) with a predetermined elastic force. Specifically, a bearing portion (not shown) that supports a rotation shaft (not shown) of the first driven roller 22B is biased by a spring. As a result, the first driven roller 22B comes into contact with the first driving roller 22A while applying a predetermined pressure thereto. When the first driving roller 22A is rotationally driven in this state, the first driven roller 22B is driven.

The sheet feed solenoid 71 is driven in accordance with a control signal from the control portion 30. When the sheet feed solenoid 71 is driven (in other words, turned on), it moves the pickup roller 29 down. Thus, the pickup roller 29 comes into contact with the sheet Sh1 stored in the sheet storing portion 27 or the sheet Sh1 conveyed from the manual feed conveying path 25, entering a state where the sheet Sh1 can be fed to the conveying path 26. On the other hand, when the sheet feed solenoid 71 is stopped (in other words, turned off), the pickup roller 29 rises and is no longer in contact with the sheet Sh1.

The pickup roller 29 receives a driving force from the motor 9 to pick up the sheets Sh1 stored in the sheet storing portion 27 one by one and conveys them to the feed roller pair 22. In addition, the pickup roller 29 receives a driving force from the motor 9 to convey the sheet Sh1 conveyed from the manual feed conveying path 25 to the feed roller pair 22. The feed roller pair 22 then receives a driving force from the motor 9 to convey the sheet Sh1 conveyed from the pickup roller 29 to the conveying path 26. The pickup roller 29 and the feed roller pair 22 correspond to a sheet feed device that conveys the sheet Sh1 to the conveying path 26.

The manual feed conveying path 25 is a guide path that guides the sheet Sh1 (manually fed sheet) inserted into the sheet feed slot 24 to the pickup roller 29. The manual feed conveying path 25 extends rightward from the sheet feed slot 24 and reaches the pickup roller 29 via two manual feed roller pairs 250.

As shown in FIG. 2, each of the two manual feed roller pairs 250 receives a driving force from the motor 9 to convey the sheet Sh1 inserted into the sheet feed slot 24, downstream in the conveying direction D12. Each of the two manual feed roller pairs 250 includes a second driving roller 250A that rotates when a driving force from the motor 9 is transmitted, and a second driven roller 250B that is brought into contact with the second driving roller 250A and is driven to rotate.

The second driving roller 250A is fixed to a rotation shaft 251 extending in the front-rear direction D2, and this rotation shaft 251 is rotatably supported by the internal frame of the housing 11. The driving force from the motor 9 is transmitted to the rotation shaft 251. The driving force of the motor 9 is transmitted to the rotation shaft 251 via a transmission mechanism (not shown) such as a gear or a belt.

The second driven roller 250B is biased toward the second driving roller 250A by a spring (not shown) with a predetermined elastic force. Specifically, a bearing portion (not shown) that supports a rotation shaft (not shown) of the second driven roller 250B is biased by a spring. Thus, the second driven roller 250B comes into contact with the second driving roller 250A while applying a predetermined pressure thereto. When the second driving roller 250A is rotationally driven in this state, the second driven roller 250B is driven.

Specifically, one (the left side one) of the two manual feed roller pairs 250 pulls the leading end of the sheet Sh1 inserted into the sheet feed slot 24 into the manual feed conveying path 25 and guides it to the other one (the right side one) of the manual feed roller pairs 250. The other one of the manual feed roller pairs 250 conveys the sheet Sh1 conveyed from one of the manual feed roller pairs 250 to the pickup roller 29.

As shown in FIG. 1, each of the image forming units 4 is provided below the intermediate transfer unit 5. Each image forming unit 4 performs an image forming process of forming a toner image on the surface of the transfer belt 5A based on image data input externally. The image forming units 4 are arranged side by side along a traveling direction D10 of the transfer belt 5A. From the left side to the right side of the transfer belt 5A, an image forming unit 4Y for yellow, an image forming unit 4C for cyan, an image forming unit 4M for magenta, and an image forming unit 4K for black are arranged in the order of appearance in a single row.

Each image forming unit 4 includes a photoconductor drum 41, a charging device 42, a developing device 43, a primary transfer roller 44, and the like. The image forming unit 4Y forms a toner image on the surface of the corresponding photoconductor drum 41 using yellow toner. The image forming unit 4C forms a toner image on the surface of the corresponding photoconductor drum 41 using cyan toner. The image forming unit 4M forms a toner image on the surface of the corresponding photoconductor drum 41 using magenta toner. The image forming unit 4K forms a toner image on the surface of the corresponding photoconductor drum 41 using black toner. The process of developing each toner image on the photoconductor drum 41 is performed by the developing device 43.

The intermediate transfer unit 5 includes a transfer belt 5A, a third driving roller 5B, and a third driven roller 5C. The transfer belt 5A is an annular belt member onto which the toner images of respective colors formed on the photoconductor drums 41 of the image forming units 4 are transferred. The transfer belt 5A is provided above the photoconductor drums 41. The transfer belt 5A is rotatably supported by the third driving roller 5B and the third driven roller 5C that are spaced apart in the left-right direction D3. The transfer belt 5A is supported so as to be stretched over the third driving roller 5B and the third driven roller 5C. When the surface of the transfer belt 5A passes between the photoconductor drums 41 and the primary transfer roller 44, the toner images are transferred from the photoconductor drums 41 in order, superimposed on top of each other.

As shown in FIG. 2, the third driving roller 5B is fixed to a rotation shaft 51 extending in the front-rear direction D2, and this rotation shaft 51 is rotatably supported by the internal frame of the housing 11. The driving force from the motor 9 is transmitted to the rotation shaft 51. The driving force of the motor 9 is transmitted to the rotation shaft 51 via a transmission mechanism (not shown) such as a gear or a belt.

The laser scanning unit 13 irradiates the photoconductor drum 41 of each image forming unit 4 with laser light based on input image data for each color. Thus, an electrostatic latent image is formed on the surface of each photoconductor drum 41.

As shown in FIG. 2, the secondary transfer roller 20 is disposed to face the third driving roller 5B with the conveying path 26 extending in the up-down direction D1 interposed therebetween. The secondary transfer roller 20 performs a transfer process of transferring the toner image on the transfer belt 5A onto the surface (transfer surface) of the sheet Sh1 by a transfer potential applied to the secondary transfer roller 20. The third driving roller 5B and the secondary transfer roller 20 correspond to an image transfer device that transfers the image (toner image) onto the sheet Sh1. The sheet Sh1 onto which the toner image has been transferred is conveyed to the fixing device 16.

As shown in FIG. 2, the fixing device 16 is a portion that heats and fixes the toner image transferred onto the sheet Sh1, and includes a heating roller 16A and a pressure roller 16B. The sheet Sh1 conveyed to the fixing device 16 is conveyed while being sandwiched between the heating roller 16A and the pressure roller 16B. During this conveyance, heat is transmitted from the heating roller 16A to the toner image transferred onto the sheet Sh1, and the toner image is heated. Thus, the toner image is fixed on the surface of the sheet Sh1. Thereafter, the sheet Sh1 is discharged to the sheet tray 18 by the sheet discharge portion 15.

In the present embodiment, the heating roller 16A functions as the driving roller, and the pressure roller 16B functions as the driven roller. Specifically, the heating roller 16A is fixed to a rotation shaft 161 extending in the front-rear direction D2, and this rotation shaft 161 is rotatably supported by the internal frame of the housing 11. The driving force from the motor 9 is transmitted to the rotation shaft 161. The driving force of the motor 9 is transmitted to the rotation shaft 161 via a transmission mechanism (not shown) such as a gear or a belt.

The pressure roller 16B is biased toward the heating roller 16A by a spring (not shown) with a predetermined elastic force. Specifically, a bearing portion (not shown) that supports a rotation shaft (not shown) of the pressure roller 16B is biased by a spring. Thus, the pressure roller 16B comes into contact with the heating roller 16A while applying a predetermined pressure thereto. When the heating roller 16A is rotationally driven in this state, the pressure roller 16B is driven.

As shown in FIG. 2, the sheet correction unit 23 is provided downstream of the feed roller pair 22 in the conveying direction D11 on the conveying path 26. Specifically, the sheet correction unit 23 is provided on the conveying path 26 between the junction of the conveying path 26 and the double-sided printing conveying path 83 and a sensor 72 (to be described later).

When the conveyed sheet Sh1 is misaligned in the front-rear direction D2 (i.e., the width direction of the sheet Sh1), the sheet correction unit 23 returns the sheet Sh1 to a predetermined center position and corrects the misalignment (lateral misalignment). In addition, the sheet correction unit 23 conveys the corrected sheet Sh1 to the image transfer device (third driving roller 5B and secondary transfer roller 20) located downstream in the conveying direction D11.

Specifically, the sheet correction unit 23 corrects the lateral misalignment of the sheet Sh1 in the width direction while the sheet Sh1 that has entered the sheet correction unit 23 is being nipped and conveyed between the registration roller 23A and the driven roller 23B. The correction is performed by moving the sheet Sh1 in the width direction toward a direction that corrects the lateral misalignment (a direction opposite to the misalignment direction) by the amount of misalignment in the width direction of the sheet Sh1. It is noted that the mechanism for moving the sheet Sh1 in the width direction is well known, and therefore, a description thereof will be omitted here.

The registration roller 23A is a roller member elongated in the front-rear direction D2. The registration roller 23A is fixed to a rotation shaft 231 extending in the front-rear direction D2, and this rotation shaft 231 is rotatably supported by the internal frame of the housing 11. The driving force from the motor 9 is transmitted to the rotation shaft 231. The driving force of the motor 9 is transmitted to the rotation shaft 231 via a transmission mechanism (not shown) such as a gear or a belt.

The registration roller 23A can function as a correction portion 230 that corrects the inclination of the sheet Sh1. Specifically, when the registration roller 23A is stopped, the sheet Sh1 that has entered the sheet correction unit 23 collides with a position (nip position) where the registration roller 23A and the driven roller 23B come into contact with each other. Thus, the inclination of the sheet Sh1 is corrected. It is noted that the registration roller 23A functions as the correction portion 230 when the registration roller 23A is stopped when the sheet Sh1 reaches the nip position. On the other hand, the registration roller 23A does not function as the correction portion 230 when the registration roller 23A is being driven when the sheet Sh1 reaches the nip position.

The driven roller 23B is biased toward the registration roller 23A by a spring (not shown) with a predetermined elastic force. Specifically, a bearing portion (not shown) that supports a rotation shaft (not shown) of the driven roller 23B is biased by a spring. Thus, the driven roller 23B comes into contact with the registration roller 23A while applying a predetermined pressure thereto. When the registration roller 23A is rotationally driven in this state, the driven roller 23B is driven.

As shown in FIG. 2, a sensor 72 is provided on the conveying path 26. The sensor 72 detects the leading edge of the sheet Sh1 that has entered the sheet correction unit 23. On the conveying path 26, the sensor 72 is provided downstream of the sheet correction unit 23 in the conveying direction D11 and upstream of the image transfer device (the third driving roller 5B and the secondary transfer roller 20) in the conveying direction D11.

The sensor 72 is, for example, a line sensor extending in the front-rear direction D2. The line sensor is composed of a plurality of image sensors arranged in a row along the front-rear direction D2. The sensor 72 is connected to the control portion 30. The sensor 72 outputs a detection signal to the control portion 30. When the control portion 30 acquires the detection signal from the sensor 72, it determines whether or not the sheet Sh1 has reached the detection position of the sensor 72 based on the detection signal.

It is noted that the sensor 72 may be an optical sensor. The optical sensor has a light emitting element and a light receiving element, receives reflected light of the light emitted from the light emitting element, and outputs a detection signal corresponding to the amount of the received light. The control portion 30 may determine whether the conveyed sheet Sh1 has reached the detection position of the sensor 72 based on the point of change in the detection signal sent from the optical sensor.

The discharge roller pair 81 is provided on the left side of the sheet discharge slot 15A in the sheet discharge portion 15. As shown in FIG. 2, the discharge roller pair 81 receives a driving force from the motor 9 to convey the sheet Sh1 to the sheet discharge slot 15A. Thus, the sheet Sh1 is discharged from the sheet discharge slot 15A.

Furthermore, when performing double-sided printing to form images on both sides of the sheet Sh1, the discharge roller pair 81 receives a driving force from the motor 9 to pull in the sheet Sh1 discharged from the sheet discharge slot 15A. Thus, the sheet Sh1 is conveyed to the double-sided printing conveying path 83.

The double-sided printing conveying path 83 is a guide path that guides the sheet Sh1, which has been conveyed again into the housing 11 by the discharge roller pair 81, to the sheet correction unit 23 again. The double-sided printing conveying path 83 curves downward from the discharge roller pair 81 and then extends downward, passing through two double-sided printing feed roller pairs 82 and reaching the sheet correction unit 23. The sheet Sh1 that has passed through the double-sided printing conveying path 83 enters the sheet correction unit 23 with its back surface, which is opposite to the front surface on which an image has already been formed, facing the registration roller 23A. This allows an image to be formed on the back surface of the sheet Sh1 as well, making double-sided printing possible on the sheet Sh1.

The discharge roller pair 81 includes a fourth driving roller 81A that rotates when a driving force from the motor 9 is transmitted, and a fourth driven roller 81B that is brought into contact with the fourth driving roller 81A and is driven to rotate.

The fourth driving roller 81A is fixed to a rotation shaft 811 extending in the front-rear direction D2, and this rotation shaft 811 is rotatably supported by the internal frame of the housing 11. The driving force from the motor 9 is transmitted to the rotation shaft 811. The driving force of the motor 9 is transmitted to the rotation shaft 811 via a transmission mechanism (not shown) such as a gear or a belt.

The fourth driven roller 81B is biased toward the fourth driving roller 81A by a spring (not shown) with a predetermined elastic force. Specifically, a bearing portion (not shown) that supports a rotation shaft (not shown) of the fourth driven roller 81B is biased by a spring. Thus, the fourth driven roller 81B comes into contact with the fourth driving roller 81A while applying a predetermined pressure thereto. When the fourth driving roller 81A is rotationally driven in this state, the fourth driven roller 81B is driven.

As shown in FIG. 2, each of the two double-sided printing feed roller pairs 82 receives a driving force from the motor 9 to convey the sheet Sh1, which has been conveyed again into the housing 11, downstream in the conveying direction D13. Each of the double-sided printing feed roller pairs 82 includes a fifth driving roller 82A that rotates when a driving force from the motor 9 is transmitted, and a fifth driven roller 82B that is brought into contact with the fifth driving roller 82A and is driven to rotate.

The fifth driving roller 82A is fixed to a rotation shaft 821 extending in the front-rear direction D2, and this rotation shaft 821 is rotatably supported by the internal frame of the housing 11. The driving force from the motor 9 is transmitted to the rotation shaft 821. The driving force of the motor 9 is transmitted to the rotation shaft 821 via a transmission mechanism (not shown) such as a gear or a belt.

The fifth driven roller 82B is biased toward the fifth driving roller 82A by a spring (not shown) with a predetermined elastic force. Specifically, a bearing portion (not shown) that supports a rotation shaft (not shown) of the fifth driven roller 82B is biased by a spring. Thus, the fifth driven roller 82B comes into contact with the fifth driving roller 82A while applying a predetermined pressure thereto. When the fifth driving roller 82A is rotationally driven in this state, the fifth driven roller 82B is driven.

The operation display portion 17 is a user interface of the image forming apparatus 10. The operation display portion 17 includes a display portion such as a liquid crystal display that displays various types of information in response to control instructions from the control portion 30, and an operation portion such as operation keys or a touch panel that inputs various types of information to the control portion 30 in response to user operations.

The control portion 30 performs overall control of the image forming apparatus 10. The control portion 30 includes a CPU, a read only memory (ROM), and a random access memory (RAM). The CPU is a processor that executes various types of arithmetic processing. The ROM is a nonvolatile storage device in which information such as control programs for causing the CPU to execute various types of processing are stored in advance. The RAM is a volatile or nonvolatile storage device used as a temporary storage memory (work area) for various types of processing executed by the CPU. The CPU performs overall control of the image forming apparatus 10 by executing various control programs stored in the ROM in advance.

It is noted that the control portion 30 may be a control portion provided separately from a main control portion that performs overall control of the image forming apparatus 10. In addition, the control portion 30 may be composed of an electronic circuit such as an application specific integrated circuit (ASIC).

As shown in FIG. 3, the control portion 30 is electrically connected to the motor 9, the sheet feed solenoid 71, the sensor 72, and the operation display portion 17 by signal lines or the like. The motor 9 is connected to a drive control portion 33 of the control portion 30, and is drive-controlled by receiving a control signal from the drive control portion 33.

The number of motors 9 may be one or more. When there is only one motor 9, for example, by providing an electromagnetic clutch or a solenoid, a plurality of rollers can be driven separately by applying driving forces from the motor 9 to the plurality of rollers separately. When there are a plurality of motors 9, a plurality of rollers can be driven separately by connecting the plurality of motors 9 to the plurality of rollers via respective transmission mechanisms (not shown).

By the way, as a related art, an image forming apparatus is known that reduces variations in longitudinal registration by making a correction to ensure a constant time from when a registration roller is driven until a leading edge of a sheet reaches a transfer position (see, for example, Patent Literature 1). In this image forming apparatus, a sheet sensor is provided downstream of the registration roller and upstream of the transfer position, and the sheet feed speed by the registration roller is increased or decreased in accordance with the time from when the registration roller is driven until the leading edge of the sheet reaches the position of the sheet sensor.

The image forming apparatus according to the related art stops the registration roller to hold the sheet at the position of the registration roller until the process of preparing an image to be transferred to the sheet is completed. After the above processing is completed, the image forming apparatus performs control to drive the registration roller to convey the sheet to the transfer position.

However, when the above control is performed, the time required for the sheet to reach the transfer position after the sheet reaches the registration roller includes the time for the sheet to wait at the position of the registration roller. Consequently, the time required for the sheet to reach the transfer position becomes longer, leading to a longer time required to form and output an image on a single sheet, which makes it difficult to increase the number of sheets on which an image can be formed per unit time depending on the situation.

Specifically, when the sheet is made to wait at the position of the registration roller, the registration roller needs to be stopped before the leading edge of the sheet reaches the position of the registration roller. This is because when the sheet reaches the position of the registration roller while the registration roller is being driven, the leading edge of the sheet passes through the registration roller and cannot be aligned with the transfer position of the image. Here, since the registration roller rotates by inertia even when the transmission of the driving force from the motor stops, it takes time until the registration roller completely stops. Therefore, when the sheet is made to wait at the position of the registration roller, it is necessary to take this time into consideration to secure a time required for the sheet to reach the transfer position.

In addition, when the sheet is made to wait at the position of the registration roller, the registration roller is driven again when the conveyance of the sheet is resumed. Here, in order to drive the registration roller, it is necessary to control a clutch provided in a transmission mechanism for transmitting a driving force from the motor to the registration roller. There is a delay time between when the clutch is controlled and when the register roller starts to rotate. Therefore, when the sheet is made to wait at the position of the registration roller, it is necessary to take the delay time into consideration to secure a time required for the sheet to reach the transfer position.

On the other hand, in the present embodiment, the configuration to be described below makes it possible to realize the image forming apparatus 10 and the operation control method capable of increasing the number of sheets on which an image is formed per unit time depending on the situation.

Specifically, as shown in FIG. 3, the image forming apparatus 10 according to the present embodiment includes the image forming portion 14 and the selection processing portion 31. In addition, in the present embodiment, the image forming apparatus 10 further includes the acquisition processing portion 32, the drive control portion 33, the sheet feed solenoid 71, the sensor 72, the motor 9, and the registration roller 23A (correction portion 230). It is noted that, in the present embodiment, the selection processing portion 31, the acquisition processing portion 32, and the drive control portion 33 are each realized as one function of the control portion 30, but may be provided separately from the control portion 30.

The motor 9 is, for example, a stepping motor and drives the rollers including the registration roller 23A. The motor 9 can change the rotational speed of the drive shaft by changing the drive frequency. The motor 9 can change the rotational speed of each roller connected to the motor 9 via a transmission mechanism (not shown) by changing the rotational speed of the drive shaft.

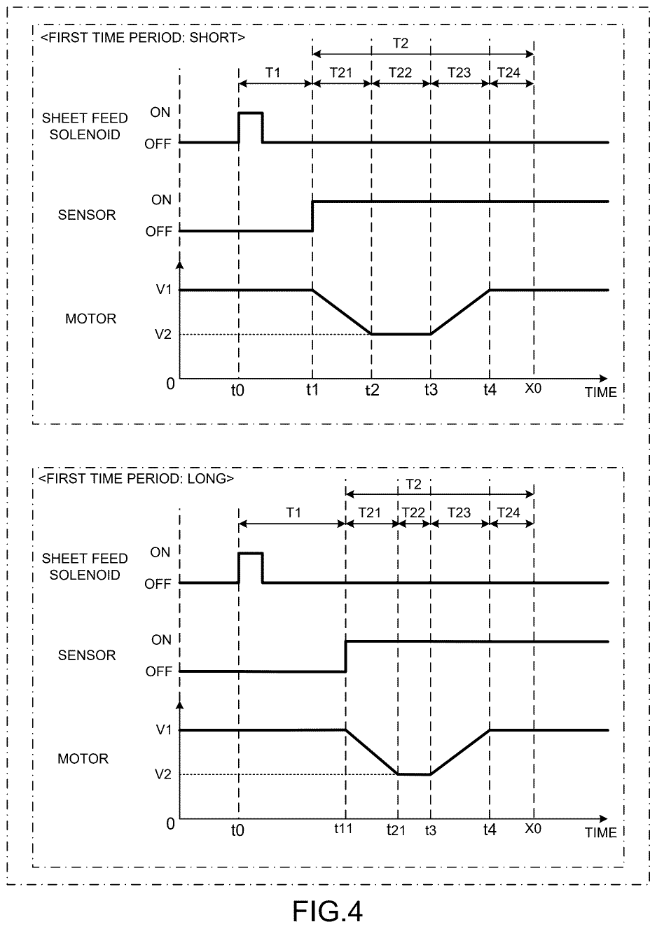

The image forming portion 14 conveys the sheet Sh1 so that the sheet Sh1 reaches the transfer position (forming position) P2 at a transfer timing (forming timing) X0 (see FIG. 4) at which image transfer (formation) is started, and forms an image on the sheet Sh1. Here, the transfer position P2 is a position where the image transfer device (the third driving roller 5B and the secondary transfer roller 20) transfers an image (toner image) onto the sheet Sh1. Specifically, the transfer position P2 is a position (nip position) where the secondary transfer roller 20 and the third driving roller 5B come into contact with each other. In addition, the transfer timing X0 is a timing at which one end in the traveling direction D10 of the image (toner image) on the transfer belt 5A reaches the transfer position P2. In addition, the sheet Sh1 reaching the transfer position P2 means that the leading edge of the sheet Sh1 in the conveying direction D11 reaches the transfer position P2. In the present embodiment, the above-described process of the image forming portion 14 is realized by the drive control portion 33 controlling the motor 9.

The selection processing portion 31 selects one of a first mode and a second mode as a mode to be used in the image forming portion 14 in accordance with a specific condition. Here, the first mode is a mode in which the sheet Sh1 is conveyed such that the sheet Sh1 reaches the transfer position P2 at the transfer timing X0 by changing the conveying speed without stopping the sheet Sh1 at the position of the correction portion 230 which corrects the inclination of the sheet Sh1. The second mode is a mode in which the sheet Sh1 is conveyed such that the sheet Sh1 reaches the transfer position P2 at the transfer timing X0 by temporarily stopping the sheet Sh1 at the position of the correction portion 230. In the present embodiment, the position of the correction portion 230 is a position (nip position) where the registration roller 23A and the driven roller 23B come into contact with each other.

Specifically, in the first mode, the image forming portion 14 changes the rotational speed of the registration roller 23A without stopping the registration roller 23A so that the sheet Sh1 reaches the transfer position P2 at the transfer timing X0. In the present embodiment, in the first mode, the image forming portion 14 decelerates the sheet Sh1 during a period from when the sheet Sh1 reaches the correction portion 230 (registration roller 23A) to when the sheet Sh1 reaches the transfer position (forming position) P2. The process of decelerating the sheet Sh1 will be described in detail later in “[2] Sheet Deceleration Process”.

In the first mode, since the sheet Sh1 is not temporarily stopped at the position of the correction portion 230, it is possible to shorten the time required for the sheet Sh1 to reach the transfer position P2 after being fed, as compared with the second mode. Therefore, in the first mode, when images are consecutively formed on a plurality of sheets Sh1, the distance between the sheets Sh1 in the conveying direction D11 (in other words, sheet interval) can be made shorter than in the second mode. Accordingly, in the first mode, as compared with the second mode, it is possible to increase the number of sheets Sh1 on which images are formed per unit time (for example, one minute), that is, to improve the productivity of the image forming apparatus 10.

In the second mode, the image forming portion 14 temporarily stops the sheet Sh1 that has reached the position of the registration roller 23A, by stopping the registration roller 23A. Then, the image forming portion 14 drives the registration roller 23A again to resume the conveyance of the sheet Sh1 so that the sheet Sh1 reaches the transfer position P2 at the transfer timing X0.

In the second mode, since the sheet Sh1 is temporarily stopped at the position of the correction portion 230, the time required for the sheet Sh1 to reach the transfer position P2 after being fed is longer than in the first mode. Therefore, in the second mode, the sheet interval is longer than that in the first mode, making it difficult to improve the productivity of the image forming apparatus 10. On the other hand, in the second mode, the inclination of the sheet Sh1 can be corrected by the correction portion 230 in the process of temporarily stopping the sheet Sh1 at the position of the correction portion 230. Therefore, in the second mode, it is possible to improve the accuracy of transferring (forming) the image onto the sheet Sh1, as compared with the first mode.

As described above, when the image forming portion 14 uses the first mode, it is possible to execute an image forming process that prioritizes the productivity of the image forming apparatus 10. In addition, when the image forming portion 14 uses the second mode, it is possible to execute an image forming process that prioritizes the accuracy of transferring (forming) the image onto the sheet Sh1.

The selection processing portion 31 can select whether to prioritize the productivity of the image forming apparatus 10 or the accuracy of transferring (forming) the image onto the sheet Sh1, depending on a specific condition—in other words, depending on the use status of the image forming apparatus 10.

The specific condition includes a condition relating to the use status of the image forming apparatus 10. For example, the specific condition includes a condition relating to the productivity required by the user when the image forming apparatus 10 is used. In addition, the specific condition includes a condition relating to the conveyance speed required by the user when the image forming apparatus 10 is used. In addition, the specific condition includes a condition relating to the sheet feed source used by the user when the image forming apparatus 10 is used. In addition, the specific condition includes a condition relating to the size of the sheet Sh1 required by the user when the image forming apparatus 10 is used.

In the present embodiment, the selection processing portion 31 uses one of the plurality of aforementioned conditions as the specific condition. Of course, the selection processing portion 31 may use a combination of two or more of the aforementioned conditions as the specific condition.

Specifically, the specific condition includes a condition relating to the number of sheets Sh1 on which an image is formed per unit time (hereinafter, also referred to as “sheet output count”) as the condition relating to the productivity. The sheet output count is, for example, Paper Per Minute (PPM), which is the number of sheets Sh1 printed (output) per minute. The sheet output count can be set, for example, by the user operating the operation display portion 17. The selection processing portion 31 selects the first mode when the sheet output count exceeds a first threshold value, and selects the second mode when the sheet output count is equal to or less than the first threshold value. The first threshold value may be appropriately set, for example, at the time of manufacture or shipment of the image forming apparatus 10.

Thus, when the productivity (here, the sheet output count) required by the user cannot be secured in the second mode, the image forming portion 14 uses the first mode so that the productivity required by the user can be secured. In addition, since the image forming portion 14 uses the second mode when the productivity required by the user can be sufficiently secured in the second mode, it becomes easy to sufficiently secure the accuracy of transferring (forming) the image onto the sheet Sh1 while securing the productivity required by the user.

In addition, the specific condition includes a condition relating to a reference conveying speed of the sheet Sh1 as the condition relating to the conveying speed. Here, the reference conveying speed is the conveying speed of the sheet Sh1 during the period from when the sheet Sh1 is fed to when the image is formed and the sheet Sh1 is discharged. In the first mode, the conveying speed of the sheet Sh1 is changed from the reference conveying speed. The reference conveying speed is represented by, for example, “1/1 speed” which is a basic speed, “1/2 speed” which is a half speed of the basic speed, or the like, and can be set by the user operating the operation display portion 17. The selection processing portion 31 selects the first mode when the reference conveying speed exceeds a second threshold value, and selects the second mode when the reference conveying speed is equal to or less than the second threshold value. The second threshold value is, for example, “1/2 speed”, but may be appropriately set at the time of manufacture or shipment of the image forming apparatus 10.

Thus, the image forming portion 14 uses the first mode when the conveying speed required by the user is high, so that the productivity corresponding to the conveying speed can be secured. In addition, since the image forming portion 14 uses the second mode when the conveying speed required by the user is low, it becomes easy to sufficiently secure the accuracy of transferring (forming) the image onto the sheet Sh1 while securing the productivity corresponding to the conveying speed. It is noted that, when the conveying speed required by the user is low, the required productivity is also low compared to when the conveying speed is high, so that even when the sheet Sh1 is temporarily stopped at the correction portion 230, the required interval between sheets can be sufficiently secured.

In addition, the specific condition includes a condition relating to the feeding of the sheet Sh1 as the condition relating to the feed source of the sheet Sh1. Here, the feed source of the sheet Sh1 is the sheet storing portion 27 (cassette) capable of storing a plurality of sheets Sh1 or the manual sheet feed slot 24 through which the user manually feeds the sheets Sh1 one by one. The feed source of the sheet Sh1 can be set by the user operating the operation display portion 17, for example. The selection processing portion 31 selects the first mode when the sheet is fed from the cassette, and selects the second mode when the sheet is fed from the manual sheet feed slot 24.

Thus, when the sheet is fed from the cassette, the image forming portion 14 uses the first mode, so that the productivity required by the user can be easily secured. In addition, when the sheet is fed from the manual sheet feed slot 24, the image forming portion 14 uses the second mode, so that it becomes easy to sufficiently secure the accuracy of transferring (forming) the image onto the sheet Sh1 while securing the productivity required by the user. It is noted that, when the sheet is fed from the manual sheet feed slot 24, the required productivity is lower than when the sheet is fed from the cassette, so that even when the sheet Sh1 is temporarily stopped at the correction portion 230, the required sheet interval can be sufficiently secured.

In addition, the specific condition includes a condition relating to the length of the sheet Sh1 in the conveying direction D11 (length in the longitudinal direction) as the condition relating to the size of the sheet Sh1. Here, the length of the sheet Sh1 in the conveying direction D11 can be set by the user operating the operation display portion 17, for example. It is noted that the length of the sheet Sh1 in the conveying direction D11 may be set numerically, or may be set by designating the size of the sheet Sh1 such as “A4” or “B5”. Then, the selection processing portion 31 selects the first mode when the length is equal to or less than a third threshold value, and selects the second mode when the length exceeds the third threshold value. The third threshold value may be appropriately set, for example, at the time of manufacture or shipment of the image forming apparatus 10.

Thus, since the image forming portion 14 uses the first mode when the length of the sheet Sh1 in the conveying direction D11 required by the user is short, the productivity corresponding to the length can be secured. In addition, since the image forming portion 14 uses the second mode when the length required by the user is long, it becomes easy to sufficiently secure the accuracy of transferring (forming) the image onto the sheet Sh1 while securing the productivity corresponding to the length. It is noted that, when the length required by the user is short, the required sheet interval is long compared to when the length is long, so that the required sheet interval can be sufficiently secured even when the sheet Sh1 is temporarily stopped at the correction portion 230.

In addition, the specific condition includes a condition relating to the thickness of the sheet as the condition relating to the size of the sheet Sh1. Here, the thickness of the sheet Sh1 can be set by the user operating the operation display portion 17, for example. It is noted that the thickness of the sheet Sh1 may be set numerically, or may be set by designating the type of the sheet Sh1 such as “plain paper”, “thick paper”, or “envelope”. The “envelope” has a shape in which a plurality of sheets are stacked in the thickness direction, and thus affects the thickness of the sheet Sh1. The selection processing portion 31 then selects the first mode when the thickness is equal to or less than a fourth threshold value, and selects the second mode when the thickness exceeds the fourth threshold value. The fourth threshold value may be appropriately set, for example, at the time of manufacture or shipment of the image forming apparatus 10.

Thus, when the thickness of the sheet Sh1 required by the user is thin, the image forming portion 14 uses the first mode, so that the productivity corresponding to the thickness can be secured. In addition, since the image forming portion 14 uses the second mode when the thickness required by the user is thick, it becomes easy to sufficiently secure the accuracy of transferring (forming) the image onto the sheet Sh1 while securing the productivity corresponding to the thickness. It is noted that, when the thickness required by the user is thick, the sheet interval is made long in consideration of the time until the image is fixed to the sheet Sh1, so that the required sheet interval can be sufficiently secured even when the sheet Sh1 is temporarily stopped at the correction portion 230.

The acquisition processing portion 32 acquires a first time period T1 (see FIG. 4) required for the sheet Sh1 to reach the position of the correction portion 230 from the sheet feed position P1. Specifically, the acquisition processing portion 32 starts measuring time when the sheet feed solenoid 71 is driven (in other words, turned on), and ends measuring time when the sensor 72 detects the sheet Sh1. Thus, the acquisition processing portion 32 acquires, as the first time period T1, the time measured from when the sheet feed solenoid 71 is driven to when the sensor 72 detects the sheet Sh1. Here, the sheet feed position P1 is a position where the sheet Sh1 is fed to the conveying path 26 by the sheet feed device (in the present embodiment, the pickup roller 29 and the feed roller pair 22). Specifically, as shown in FIG. 2, the sheet feed position P1 is a position (nip position) where two rollers of the feed roller pair 22 come into contact with each other.

The drive control portion 33 controls the motor 9 in accordance with a control instruction from the control portion 30. The drive control portion 33 then controls the motor 9 to control the registration roller 23A so that the sheet Sh1 reaches the transfer position P2 at the transfer timing X0 at which the transfer of the image (toner image) is started.

### [2] Sheet Deceleration Process

The deceleration process of the sheet Sh1 when the image forming portion 14 uses the first mode will be described below with reference to FIG. 4. In the example shown in FIG. 4, the drive control portion 33 controls the motor 9 to change the rotational speed of the motor 9, and consequently the rotational speed of the registration roller 23A during a second time period T2 in accordance with the first time period T1. The second time period T2 is a time period from when the sheet Sh1 reaches the registration roller 23A to when the sheet Sh1 reaches the transfer position P2. Specifically, the second time period T2 is a time period from the timing at which the sensor 72 detects the sheet Sh1 to the transfer timing X0 at which the transfer of the image (toner image) is started.

The transfer timing X0 is determined by the control portion 30 based on the time required for the process of forming the image (toner image) on the transfer belt 5A and the time required for one end in the traveling direction D10 of the image (toner image) on the transfer belt 5A to reach the transfer position P2. Therefore, the second time period T2 can be calculated by obtaining a difference between the transfer timing X0 set by the control portion 30 and the timing at which the sensor 72 detected the sheet Sh1.

Specifically, the drive control portion 33 changes the rotational speed of the motor 9 from a first rotational speed V1 to a second rotational speed V2 by controlling the motor 9 during the second time period T2. The first rotational speed V1 is the rotational speed of the motor 9 during the first time period T1 and is the normal rotational speed of the motor 9. That is, the motor 9 rotates at the first rotational speed V1, which is the normal rotational speed, while the sheet Sh1 travels from the sheet feed position P1 to the registration roller 23A. The second rotational speed V2 is a rotational speed lower than the first rotational speed V1. In the present embodiment, the second rotational speed V2 is, for example, half the rotational speed of the first rotational speed V1, which is the normal rotational speed. It is noted that the second rotational speed V2 does not have to be half the first rotational speed V1; it only needs to be lower than the first rotational speed V1.

For example, if the motor 9 continues to rotate at the first rotational speed V1, the sheet Sh1 may reach the transfer position P2 before the transfer timing X0. In this case, the leading edge of the sheet Sh1 in the conveying direction D11 and one end of the image (toner image) on the transfer belt 5A in the traveling direction D10 do not align at the transfer position P2, and the transfer of the image to the sheet Sh1 is not performed with high accuracy. Therefore, as described above, the drive control portion 33 reduces the rotational speed of the motor 9 from the first rotational speed V1 to the second rotational speed V2 during the second time period T2. This enables the sheet Sh1 to reach the transfer position P2 at the transfer timing X0, facilitating accurate image transfer onto the sheet Sh1.

In addition, as described above, the drive control portion 33 changes the rotational speed of the motor 9 in accordance with the first time period T1 acquired by the acquisition processing portion 32. Here, the first time period T1 may vary, for example, due to the load of the conveyance of the sheet Sh1 at the start of the rotation of the pickup roller 29 or the feed roller pair 22 or due to the sheet Sh1 slipping, for example, because of the state of the surface of the sheet Sh1 (such as variations in the friction coefficient). Therefore, the drive control portion 33 changes the rotational speed of the motor 9 in accordance with the first time period T1 so that it can make the sheet Sh1 reach the transfer position P2 at the transfer timing X0 regardless of variations in the first time period T1.

Specifically, the drive control portion 33 changes the rotational speed of the motor 9 so that the sum of the first time period T1 and the second time period T2 becomes a predetermined constant value. For example, when the first time period T1 is shorter than a reference time period, the drive control portion 33 changes the rotational speed of the motor 9 so that the second time period T2 becomes longer by the difference between the first time period T1 and the reference time period. In addition, for example, when the first time period T1 is longer than the reference time period, the drive control portion 33 changes the rotational speed of the motor 9 so that the second time period T2 becomes shorter by the difference between the first time period T1 and the reference time period.

In the present embodiment, the second time period T2 includes a deceleration time period T21, a first maintaining time period T22, an acceleration time period T23, and a second maintaining time period T24. The deceleration time period T21 is a time period for decelerating the rotational speed of the motor 9 from the first rotational speed V1 to the second rotational speed V2. The drive control portion 33 reduces the rotational speed of the motor 9 at a predetermined deceleration rate by changing the drive frequency of the motor 9. The first maintaining time period T22 is a time period following the deceleration time period T21, during which the rotational speed of the motor 9 is maintained at the second rotational speed V2. The drive control portion 33 maintains the rotational speed of the motor 9 by controlling the drive frequency of the motor 9 to be constant. The acceleration time period T23 is a time period following the first maintaining time period T22, during which the rotational speed of the motor 9 is increased from the second rotational speed V2 to the first rotational speed V1. The drive control portion 33 increases the rotational speed of the motor 9 at a predetermined acceleration rate by changing the drive frequency of the motor 9. Here, the absolute values of the deceleration rate and the acceleration rate are the same.

In addition, the second time period T2 further includes the second maintaining time period T24. The second maintaining time period T24 is a time period following the acceleration time period T23, during which the rotational speed of the motor 9 is maintained at the first rotational speed V1. The drive control portion 33 maintains the rotational speed of the motor 9 by controlling the drive frequency of the motor 9 to be constant. The second maintaining time period T24 is set such that, for example, the distance between the leading edge of the sheet Sh1 in the conveying direction D11 and the transfer position P2 at the start of the second maintaining time period T24 is approximately several millimeters.

This makes it possible to stabilize the speed at which the sheet Sh1 is conveyed before the sheet Sh1 reaches the transfer position P2. Therefore, compared to when the speed at which the sheet Sh1 is conveyed changes as it reaches the transfer position P2, it is easier to have the sheet Sh1 reach the transfer position P2 at the transfer timing X0. It is noted that, it is not essential to include the second maintaining time period T24 in the second time period T2.

Specifically, as shown in FIG. 4, the drive control portion 33 first reduces the rotational speed of the motor 9 from the first rotational speed V1 to the second rotational speed V2 at a predetermined deceleration rate during the deceleration time period T21. Next, the drive control portion 33 maintains the rotational speed of the motor 9 at the second rotational speed V2 during the first maintaining time period T22. Next, during the acceleration time period T23, the drive control portion 33 increases the rotational speed of the motor 9 from the second rotational speed V2 to the first rotational speed V1 at a predetermined acceleration rate. Thereafter, the drive control portion 33 maintains the rotational speed of the motor 9 at the first rotational speed V1 during the second maintaining time period T24.

As described above, the drive control portion 33 controls the motor 9 such that the second time period T2 includes the first maintaining time period T22, that is, includes a time period during which the rotational speed of the motor 9 is maintained at the second rotational speed V2. Thus, by changing the length of the first maintaining time period T22 in accordance with the first time period T1, it is possible to cause the sheet Sh1 to reach the transfer position P2 at the transfer timing X0 regardless of variations in the first time period T1. In addition, in this case, the lengths of the deceleration time period T21 and the acceleration time period T23 need not be changed in accordance with the first time period T1. Therefore, compared with the case where the deceleration time period T21 and the acceleration time period T23 are changed, the control for changing the rotational speed of the motor 9 becomes easy.

Specifically, in the example shown in <first time period: short> in FIG. 4, the first time period T1 is a time period from the time t0 when the sheet feed solenoid 71 is turned on to the time t1 when the sensor 72 detects the sheet Sh1. The second time period T2 is set to a time period from the time t1 to the transfer timing X0, the deceleration time period T21 is set to a time period from the time t1 to the time t2, the first maintaining time period T22 is set to a time period from the time t2 to the time t3, and the acceleration time period T23 is set to a time period from the time t3 to the time t4. In addition, the second maintaining time period T24 is set to a time period from the time t4 to the transfer timing X0.

On the other hand, in the example shown in <first time period: long> in FIG. 4, the first time period T1 is a time period from the time t0 when the sheet feed solenoid 71 is turned on to the time t11 (>t1) when the sensor 72 detects the sheet Sh1, and is longer than in the example shown in <first time period: short>. The second time period T2 is set to a time period from the time t11 to the transfer timing X0, the deceleration time period T21 is set to a time period from the time t11 to the time t21 (>t2), the first maintaining time period T22 is set to a time period from the time t21 to the time t3. In addition, the acceleration time period T23 is set to a time period from the time t3 to the time t4, and the second maintaining time period T24 is set to a time period from the time t4 to the transfer timing X0. It is noted that the length of the deceleration time period is the same as the length of the deceleration time period in the example of the <first time period: long>.

That is, in the example shown in <first time period: long> in FIG. 4, the drive control portion 33 controls the motor 9 so as to change the length of only the first maintaining time period T22 as the first time period T1 becomes longer. Therefore, the lengths of the deceleration time period T21, the acceleration time period T23, and the second maintaining time period T24 are the same in both examples of <first time period: short> and <first time period: long> in FIG. 4.

### [3] Operation Example of Image Forming Apparatus

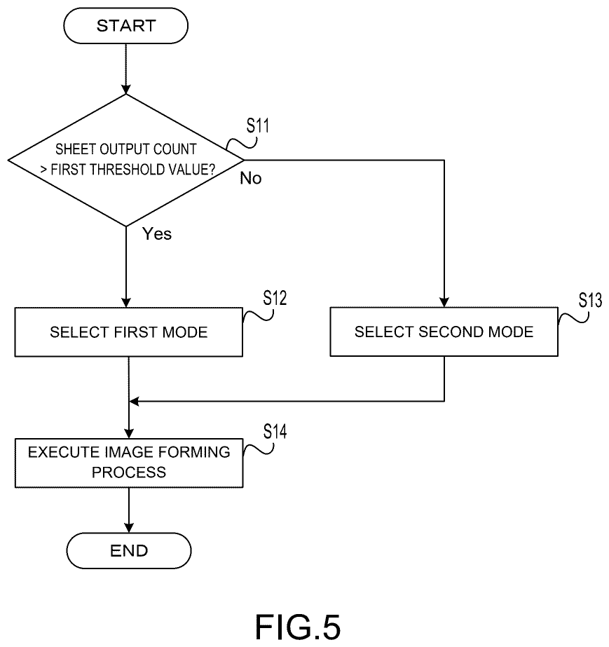

Hereinafter, an example of the control method of the image forming apparatus 10 according to the present embodiment will be described with reference to FIG. 5 to FIG. 9, together with an example of the procedure of the processing executed by the image forming apparatus 10. Here, steps S11, S12, . . . represent the numbers of the processing procedure (steps) executed by the image forming apparatus 10. The processing described below is started before executing the image forming process of forming an image on the sheet Sh1. Further, although the first operation example to the fifth operation example will be described as operation examples of the image forming apparatus 10, the operation of the image forming apparatus 10 is not limited to these operation examples.

### First Operation Example

The first application example of the image forming apparatus 10 will be described below with reference to FIG. 5. The first operation example is an operation example when the condition relating to the sheet output count is the specific condition.

### Step S11

First, the selection processing portion 31 compares the sheet output count with the first threshold value. The sheet output count is set in advance by the user operating the operation display portion 17. When the sheet output count exceeds the first threshold value (step S11: Yes), the selection processing portion 31 executes step S12. On the other hand, when the sheet output count is equal to or less than the first threshold value (step S11: No), the selection processing portion 31 executes step S13.

### Step S12

The selection processing portion 31 selects the first mode as the mode used in the image forming portion 14. Then, the image forming apparatus 10 next executes step S14.

### Step S13

The selection processing portion 31 selects the second mode as the mode used in the image forming portion 14. Then, the image forming apparatus 10 next executes step S14.

### Step S14

The image forming portion 14 executes the image forming process using the mode selected by the selection processing portion 31. When using the first mode, the image forming portion 14 conveys the sheet Sh1 by changing the rotational speed without stopping the registration roller 23A so that the sheet Sh1 reaches the transfer position P2 at the transfer timing X0. In addition, when using the second mode, the image forming portion 14 temporarily stops the sheet Sh1 that has reached the position of the registration roller 23A by stopping the registration roller 23A. Then, the image forming portion 14 drives the registration roller 23A again to resume the conveyance of the sheet Sh1 so that the sheet Sh1 reaches the transfer position P2 at the transfer timing X0.

### Second Operation Example

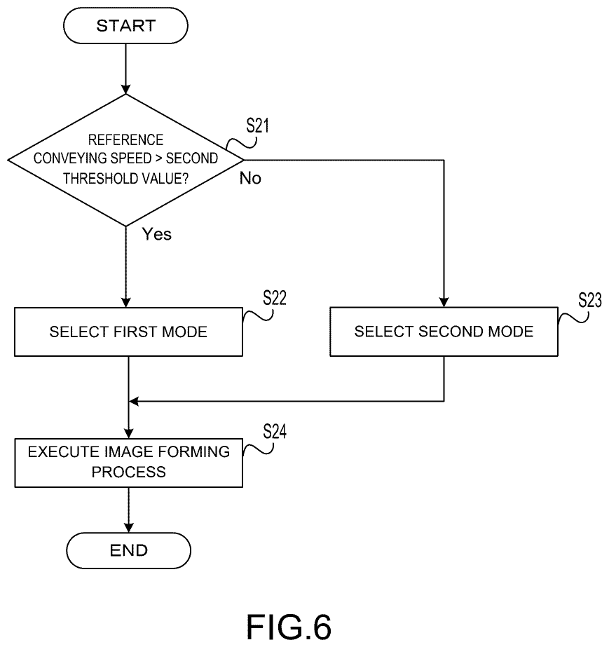

The second operation example of the image forming apparatus 10 will be described below with reference to FIG. 6. The second operation example is an operation example when the condition relating to the reference conveying speed of the sheet Sh1 is the specific condition.

### Step S21

First, the selection processing portion 31 compares the reference conveying speed with the second threshold value. The reference conveying speed is set in advance by the user operating the operation display portion 17. When the reference conveying speed exceeds the second threshold value (step S21: Yes), the selection processing portion 31 executes step S22. On the other hand, when the reference conveying speed is equal to or less than the second threshold value (step S21: No), the selection processing portion 31 executes step S23.

### Step S22

The selection processing portion 31 selects the first mode as the mode used in the image forming portion 14. Then, the image forming apparatus 10 next executes step S24.

### Step S23

The selection processing portion 31 selects the second mode as the mode used in the image forming portion 14. Then, the image forming apparatus 10 next executes step S24.

### Step S24

The image forming portion 14 executes the image forming process using the mode selected by the selection processing portion 31. When using the first mode, the image forming portion 14 conveys the sheet Sh1 by changing the rotational speed without stopping the registration roller 23A so that the sheet Sh1 reaches the transfer position P2 at the transfer timing X0. In addition, when using the second mode, the image forming portion 14 temporarily stops the sheet Sh1 that has reached the position of the registration roller 23A by stopping the registration roller 23A. Then, the image forming portion 14 drives the registration roller 23A again to resume the conveyance of the sheet Sh1 so that the sheet Sh1 reaches the transfer position P2 at the transfer timing X0.

### Third Operation Example

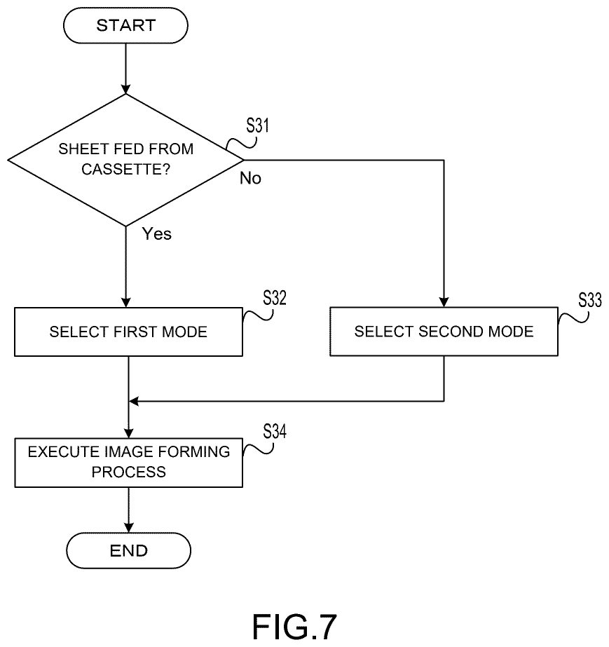

The third operation example of the image forming apparatus 10 will be described below with reference to FIG. 7. The third operation example is an operation example when the condition relating to the feeding of the sheet Sh1 is the specific condition.

### Step S31

First, the selection processing portion 31 confirms whether the sheet feed source of the sheet Sh1 is the cassette (sheet storing portion 27) or the manual sheet feed slot 24. The sheet feed source of the sheet Sh1 is set in advance by the user operating the operation display portion 17. When the sheet feed source of the sheet Sh1 is the cassette (step S31: Yes), the selection processing portion 31 executes step S12. On the other hand, when the sheet feed source of the sheet Sh1 is the manual sheet feed slot 24 (step S31: No), the selection processing portion 31 executes step S13.

### Step S32

The selection processing portion 31 selects the first mode as the mode used in the image forming portion 14. Then, the image forming apparatus 10 next executes step S34.

### Step S33

The selection processing portion 31 selects the second mode as the mode used in the image forming portion 14. Then, the image forming apparatus 10 next executes step S34.

### Step S34

The image forming portion 14 executes the image forming process using the mode selected by the selection processing portion 31. When using the first mode, the image forming portion 14 conveys the sheet Sh1 by changing the rotational speed without stopping the registration roller 23A so that the sheet Sh1 reaches the transfer position P2 at the transfer timing X0. In addition, when using the second mode, the image forming portion 14 temporarily stops the sheet Sh1 that has reached the position of the registration roller 23A by stopping the registration roller 23A. Then, the image forming portion 14 drives the registration roller 23A again to resume the conveyance of the sheet Sh1 so that the sheet Sh1 reaches the transfer position P2 at the transfer timing X0.

### Fourth Operation Example

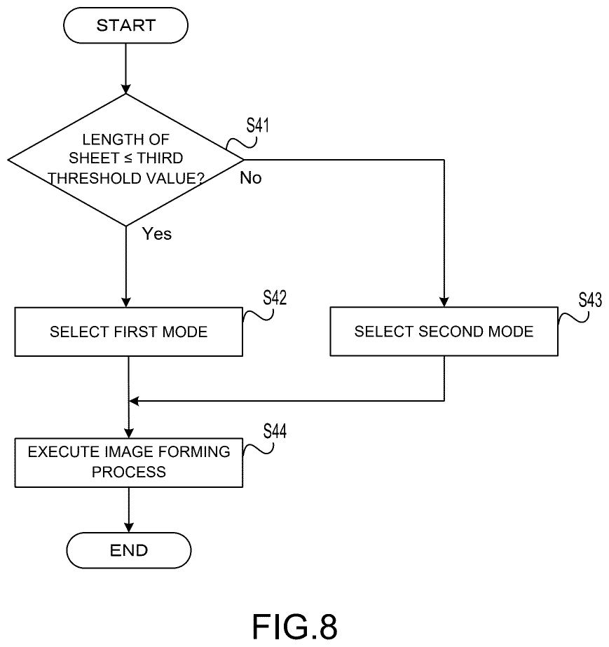

The fourth operation example of the image forming apparatus 10 will be described below with reference to FIG. 8. The fourth operation example is an operation example when the condition relating to the length of the sheet Sh1 in the conveying direction D11 (hereinafter, also referred to as “the length of the sheet Sh1”) is the specific condition.

### Step S41

First, the selection processing portion 31 compares the length of the sheet Sh1 with the third threshold value. The length of the sheet Sh1 is set in advance by the user operating the operation display portion 17. When the length of the sheet Sh1 is equal to or less than the third threshold value (step S41: Yes), the selection processing portion 31 executes step S42. On the other hand, when the length of the sheet Sh1 exceeds the third threshold value (step S41: No), the selection processing portion 31 executes step S43.

### Step S42

The selection processing portion 31 selects the first mode as the mode used in the image forming portion 14. Then, the image forming apparatus 10 next executes step S44.

### Step S43

The selection processing portion 31 selects the second mode as the mode used in the image forming portion 14. Then, the image forming apparatus 10 next executes step S44.

### Step S44

The image forming portion 14 executes the image forming process using the mode selected by the selection processing portion 31. When using the first mode, the image forming portion 14 conveys the sheet Sh1 by changing the rotational speed without stopping the registration roller 23A so that the sheet Sh1 reaches the transfer position P2 at the transfer timing X0. In addition, when using the second mode, the image forming portion 14 temporarily stops the sheet Sh1 that has reached the position of the registration roller 23A by stopping the registration roller 23A. Then, the image forming portion 14 drives the registration roller 23A again to resume the conveyance of the sheet Sh1 so that the sheet Sh1 reaches the transfer position P2 at the transfer timing X0.

### Fifth Operation Example

The fifth operation example of the image forming apparatus 10 will be

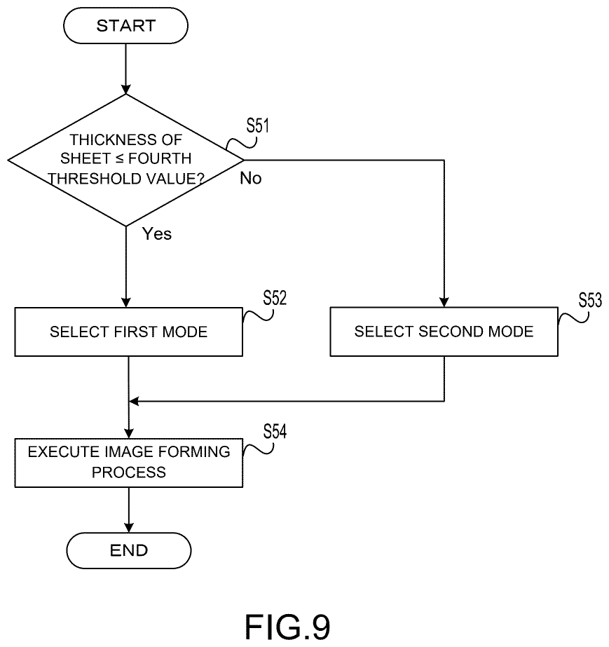

described below with reference to FIG. 9. The fifth operation example is an operation example when the condition relating to the thickness of the sheet Sh1 is the specific condition.

### Step S51

First, the selection processing portion 31 compares the thickness of the sheet Sh1 with the fourth threshold value. The thickness of the sheet Sh1 is set in advance by the user operating the operation display portion 17. When the thickness of the sheet Sh1 is equal to or less than the fourth threshold value (step S51: Yes), the selection processing portion 31 executes step S52. On the other hand, when the thickness of the sheet Sh1 exceeds the fourth threshold value (step S51: No), the selection processing portion 31 executes step S53.

### Step S52

The selection processing portion 31 selects the first mode as the mode used in the image forming portion 14. Then, the image forming apparatus 10 next executes step S54.

### Step S53

The selection processing portion 31 selects the second mode as the mode used in the image forming portion 14. Then, the image forming apparatus 10 next executes step S54.

### Step S54

The image forming portion 14 executes the image forming process using the mode selected by the selection processing portion 31. When using the first mode, the image forming portion 14 conveys the sheet Sh1 by changing the rotational speed without stopping the registration roller 23A so that the sheet Sh1 reaches the transfer position P2 at the transfer timing X0. In addition, when using the second mode, the image forming portion 14 temporarily stops the sheet Sh1 that has reached the position of the registration roller 23A by stopping the registration roller 23A. Then, the image forming portion 14 drives the registration roller 23A again to resume the conveyance of the sheet Sh1 so that the sheet Sh1 reaches the transfer position P2 at the transfer timing X0.

As described above, the image forming apparatus 10 according to the present embodiment can select a mode to be used in the image forming portion 14 from the first mode and the second mode in accordance with the specific condition. Therefore, in the present embodiment, since the image forming portion 14 uses the first mode depending on the use status of the image forming apparatus 10, the sheet Sh1 does not have to wait at the position of the registration roller 23A, and the sheet output count can be increased. That is, in the present embodiment, it is possible to increase the number of sheets on which an image is formed per unit time (the sheet output count) depending on the situation. In addition, in the present embodiment, as long as the sheet output count required by the user can be sufficiently secured, since the image forming portion 14 uses the second mode, it is possible to improve the accuracy of transferring (forming) the image onto the sheet Sh1 as compared with the case of using the first mode.

### Modifications

In the above-described embodiment, the drive control portion 33 may control the motor 9 so as to change the rotational speed of the motor 9 without taking the first time period T1 into consideration. In this case, the image forming apparatus 10 does not have to include the acquisition processing portion 32. In addition, in this case, the drive control portion 33 may change the rotational speed of the motor 9 so that the sheet Sh1 reaches the transfer position P2 at the transfer timing X0 without waiting for the sheet Sh1 to reach the registration roller 23A.

In the above-described embodiment, the sensor 72 is positioned downstream of the registration roller 23A in the conveying direction D11, but the configuration is not limited this. For example, the sensor 72 may be positioned upstream of the registration roller 23A in the conveying direction D11.

In the above-described embodiment, the relationship between the driving roller and the driven roller in each roller pair may be reversed. For example, in the feed roller pair 22, the first driving roller 22A may be a driven roller, and the first driven roller 22B may be a driving roller. In addition, in the above-described embodiment, both the two rollers in each roller pair may be driving rollers.

In the above-described embodiment, the image forming apparatus 10 does not have to have the double-sided printing function. When the image forming apparatus 10 does not have the double-sided printing function, the configuration relating to the double-sided printing function is unnecessary. Specifically, in this case, the image forming apparatus 10 does not have to be provided with the two double-sided printing feed roller pairs 82 and the double-sided printing conveying path 83.

In the above-described embodiment, the image forming apparatus 10 has a print function of forming a monochrome image or a color image on the sheet Sh1, but the configuration is not limited to this. For example, the image forming apparatus 10 may have a print function of forming only a monochrome image on the sheet Sh1.

In the above-described embodiment, the image forming apparatus 10 has a function of executing a process of forming a monochrome image or a color image on the sheet Sh1 based on the electrophotographic method, but the configuration is not limited to this. For example, the image forming apparatus 10 may have a function of executing a process of forming a monochrome image or a color image on the sheet Sh1 based on the inkjet method.

### Appendixes to Disclosure

The following are appendixes to the overview of the disclosure extracted from the above-described embodiment. It is noted that the structures and processing functions to be described in the following appendixes can be selected and combined arbitrarily.

### Appendix 1

An image forming apparatus comprising:
an image forming portion configured to convey a sheet so that the sheet reaches a forming position at a forming timing at which formation of an image is started, and form the image on the sheet; and
a selection processing portion configured to select, as a mode to be used in the image forming portion, one of a first mode in which a conveying speed is changed without stopping the sheet at a position of a correction portion for correcting an inclination of the sheet and a second mode in which the sheet is temporarily stopped at the position of the correction portion, in accordance with a specific condition.

### Appendix 2

The image forming apparatus according to Appendix 1, wherein
the specific condition includes a condition relating to a number of the sheets on which the image is formed per unit time, and
the selection processing portion selects the first mode when the number of the sheets exceeds a first threshold value, and selects the second mode when the number of the sheets is equal to or less than the first threshold value.

### Appendix 3

The image forming apparatus according to Appendix 1 or 2, wherein
the specific condition includes a condition relating to a reference conveying speed of the sheet, and
the selection processing portion selects the first mode when the reference conveying speed exceeds a second threshold value, and selects the second mode when the reference conveying speed is equal to or less than the second threshold value.

### Appendix 4

The image forming apparatus according to any one of Appendixes 1 to 3, wherein
the specific condition includes a condition relating to feeding of the sheet, and
the selection processing portion selects the first mode when the sheet is fed from a cassette capable of storing a plurality of the sheets, and selects the second mode when the sheet is fed from a manual sheet feed slot.

### Appendix 5

The image forming apparatus according to any one of Appendixes 1 to 4, wherein
the specific condition includes a condition relating to a length of the sheet in a conveying direction, and
the selection processing portion selects the first mode when the length is equal to or less than a third threshold value and selects the second mode when the length exceeds the third threshold value.

### Appendix 6

The image forming apparatus according to any one of Appendixes 1 to 5, wherein
the specific condition includes a condition relating to a thickness of the sheet, and
the selection processing portion selects the first mode when the thickness is equal to or less than a fourth threshold value, and selects the second mode when the thickness exceeds the fourth threshold value.

### Appendix 7

The image forming apparatus according to any one of Appendixes 1 to 6, wherein
in the first mode, the image forming portion decelerates the sheet between when the sheet reaches the correction portion and when the sheet reaches the forming position.

### Appendix 8

A control method of an image forming apparatus, comprising:
conveying a sheet so that the sheet reaches a forming position at a forming timing at which formation of an image is started, and forming the image on the sheet; and
selecting, as a mode to be used in a process of forming the image, one of a first mode in which a conveying speed is changed without stopping the sheet at a position of a correction portion for correcting an inclination of the sheet and a second mode in which the sheet is temporarily stopped at the position of the correction portion, in accordance with a specific condition.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to convey a sheet so that the sheet reaches a forming position at a forming timing at which formation of an image is started, and form the image on the sheet; and
a selection processing portion configured to select, as a mode to be used in the image forming portion, one of a first mode in which a conveying speed is changed without stopping the sheet at a position of a correction portion for correcting an inclination of the sheet and a second mode in which the sheet is temporarily stopped at the position of the correction portion, in accordance with a specific condition.

2. The image forming apparatus according to claim 1, wherein
the specific condition includes a condition relating to a number of the sheets on which the image is formed per unit time, and
the selection processing portion selects the first mode when the number of the sheets exceeds a first threshold value, and selects the second mode when the number of the sheets is equal to or less than the first threshold value.

3. The image forming apparatus according to claim 1, wherein
the specific condition includes a condition relating to a reference conveying speed of the sheet, and
the selection processing portion selects the first mode when the reference conveying speed exceeds a second threshold value, and selects the second mode when the reference conveying speed is equal to or less than the second threshold value.

4. The image forming apparatus according to claim 1, wherein
the specific condition includes a condition relating to feeding of the sheet, and
the selection processing portion selects the first mode when the sheet is fed from a cassette capable of storing a plurality of the sheets, and selects the second mode when the sheet is fed from a manual sheet feed slot.

5. The image forming apparatus according to claim 1, wherein
the specific condition includes a condition relating to a length of the sheet in a conveying direction, and
the selection processing portion selects the first mode when the length is equal to or less than a third threshold value and selects the second mode when the length exceeds the third threshold value.

6. The image forming apparatus according to claim 1, wherein
the specific condition includes a condition relating to a thickness of the sheet, and
the selection processing portion selects the first mode when the thickness is equal to or less than a fourth threshold value, and selects the second mode when the thickness exceeds the fourth threshold value.

7. The image forming apparatus according to claim 1, wherein
in the first mode, the image forming portion decelerates the sheet between when the sheet reaches the correction portion and when the sheet reaches the forming position.

8. A control method of an image forming apparatus, comprising:
conveying a sheet so that the sheet reaches a forming position at a forming timing at which formation of an image is started, and forming the image on the sheet; and
selecting, as a mode to be used in a process of forming the image, one of a first mode in which a conveying speed is changed without stopping the sheet at a position of a correction portion for correcting an inclination of the sheet and a second mode in which the sheet is temporarily stopped at the position of the correction portion, in accordance with a specific condition.
